(19) United States
(12) Patent Application Publication
(10) Pub. No.: US 2007/0192402 A1
(43) Pub. Date: Aug. 16, 2007

(54) System and method for automating workflow

(75) Inventors: John C. Dean JR., Atlanta, GA (US); Jim Cross, Avondale Estates, GA (US); Darrin Deck, Suwanee, GA (US); Alla Gurvich, (US); Colm Hoban, Roswell, GA (US); Sean Giles, Lawrenceville, GA (US)

Correspondence Address: MCKENNA LONG & ALDRIDGE LLP;Song K. Jung, 1900 K Street, N.W., Washington, DC, 20006, US

(73) Assignee: TRX, Inc., Atlanta, GA (US)

(21) Appl. No.: 11/391,712

(22) Filed: Mar. 29, 2006

Related U.S. Application Data
(60) Provisional application No. 60/665,866, filed on Mar. 29, 2005.

(51) Int. Cl. G06F 15/16

(52) U.S. Cl. 709/202

(57) ABSTRACT

Systems and methods for assigning, delivering, and monitoring tasks are discussed that allow the supervisor to view a task type on which a agent below the supervisor in the hierarchy is working, the amount of time that the agent is taking to complete that task, and the target amount of time that are spent to complete such a task. The supervisor can also define the types of tasks that a particular agent can receive and be assigned. This mechanism would allow the supervisor to dynamically manage resources, enabling the supervisor to assign additional resources to short-term anomalies efficiently. In other words, the system allows supervisors to assign tasks to their agent based on agents known skill sets and the skills required to complete the task.

This application claims the benefit of U.S. Provisional Patent Application No. 60/665,866, filed on Mar. 29, 2005, which is hereby incorporated by reference for all purposes as if fully set forth herein.

### BACKGROUND TO THE INVENTION

1. Field of the Invention

The present invention relates to systems and methods for managing workflow within a travel agency or booking environment.

2. Discussion of the Related Art

In managing travel agency and booking workflow, it is necessary to have a system that can efficiently deliver tasks to agents. However, the complexity and granularity of the tasks in this environment are such that traditional workflow systems become cumbersome, inefficient and ineffective. These systems do not adequately meet the needs of the travel agency environment.

### SUMMARY OF THE INVENTION

Accordingly, the present invention is directed to systems and methods for automating workflow that substantially obviates one or more of the problems due to limitations and disadvantages of the related art.

An advantage of the present invention is to provide a system for automating workflow associated with travel agents, including a plurality of first agents, at least one of a second agent, at least one unit of incoming work, said second agent examining said unit of incoming work and creating a new task associated with said unit of work, said task defined at least in part by a skill identifier associated with the agent skill required to complete said task, a list of skill identifiers associated with each of said first agents corresponding to the skills possessed by said agent, at least one task queue corresponding to each of said first agents, assigning said new task to one of said first agents, said one of said first agents having a skill identifier in its list corresponding to the skill identifier of the task, a completion time for said new task determined by subtracting the time the task was assigned to the first agent from the time the task was completed by said first agent.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates the roles and duties of the four users in this system.

FIG. 2 is a diagram of the system flow according to an embodiment of the present invention.

FIG. 3 illustrates the process flow of a software system of the present invention.

### DETAILED DESCRIPTION OF THE ILLUSTRATED EMBODIMENTS

Reference will now be made in detail to embodiments of the present invention, example of which is illustrated in the accompanying drawings.

The workflow system of the present invention includes a task, which is a unit of work such as that corresponding to an email, one PNR, one phone call, or the like; an agent, which is a person or entity that completes that task; one or more supervisors who oversee teams of agents and sometimes help them complete their work; and managers who oversee the supervisors.

The system of the present invention delivers tasks to agents and allows the agent to categorize the task. The system also captures the amount of time that the agent spent completing the task, thus helping to increase efficiency and productivity by capturing productivity-related data more accurately than in related art systems.

This system will also allow supervisors to dynamically monitor their agents and the tasks they are working on at any given time. The monitoring system allows the supervisor to see the task type on which the agent is working, the amount of time that the agent is taking to complete that task, and the target amount of time that are spent to complete such a task. The system of the present invention thus empowers the supervisor to more effectively coach and manage their team. The supervisor also has the ability to define the types of tasks that a particular agent can receive and be assigned. This mechanism would allow the supervisor to dynamically manage her resources, enabling her to assign additional resources to short-term anomalies efficiently. In other words, the system allows supervisors to assign tasks to their agent based on agents known skill sets and the skills required to complete the task.

A real time analysis console may also be included in this system. This console will display the current volume of tasks by task category as well as based on the system's current throughput and processing bottlenecks. This display includes the ability to drill down to ever-increasing levels of details, such as to the supervisory or agent level and allow the user to isolate a specific hotspot. The automation features of the system provide information to this console thereby ensuring that a complete image of the system is provided at any point in time.

Finally, this system fully integrated with application security models and also ensures that the end users will not require an additional login to work within this system.

The system will benefit the supervisors and managers who, because they use related art systems, currently lack data regarding the number and timing of tasks that their agents perform and are unable to effectively manage their teams and bill their clients. If implemented properly, this system will also provide unexpected benefits as subject matter experts are able to analyze the data that this system collects.

There are four different users of this system, each with different needs. Throughout this description, the term “agent” is used. In those instances “agent” will apply to both Queue Agents and Mail Agents. If the requirement pertains to only one type of agent then that agent is referred to appropriately.

First are agents, who interact with the system and who require a responsive, reliable, usable interface. There are two types of agents, Queue Agents and Mail Agents. Queue agents work off a queue based system and Mail Agents process incoming mail and place items on those queues related to the incoming mail. Second are supervisors who require a flexible user interface that displays pertinent, timely information about their teams. Third are Managers who need to see information regarding the health of the system and confirm that numbers pertinent to their supervisors are delivered in a timely and usable format. Fourth are Administrators who needs an intuitive interface that allows them to easily define system parameters.

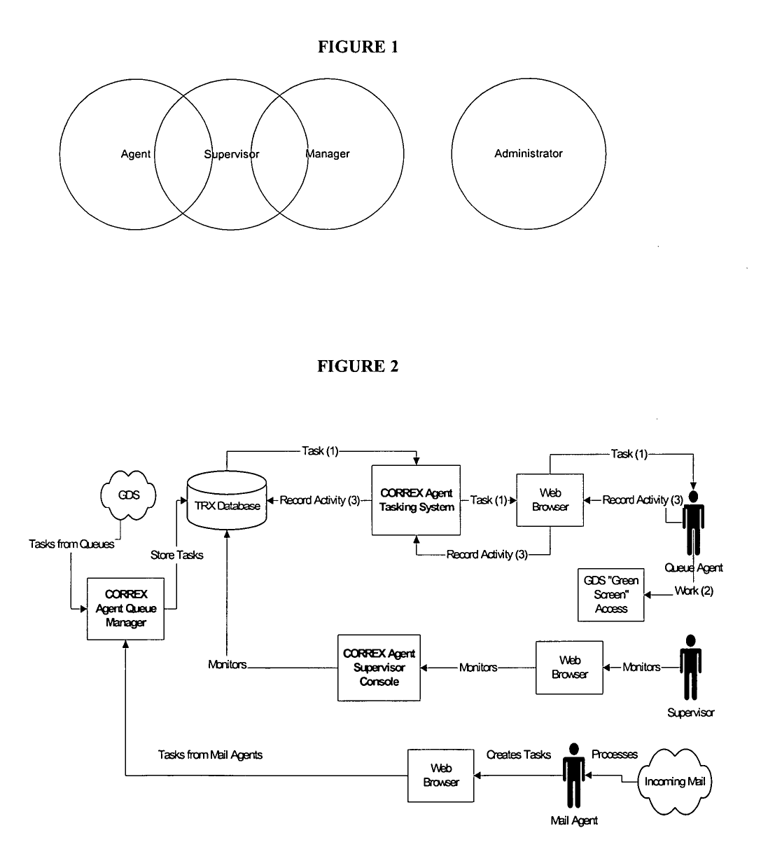

FIG. 1 illustrates the roles and duties of the four users in this system. In particular, FIG. 1 illustrates the overlapping roles of the supervisors and the agents.

As noted above, Queue Agents are the users who perform tasks in queues. An agent's skill set can range from novice to expert, but all agents are travel savvy. Agents are responsible for completing sets of tasks, such as responding to an email, refinding a ticket or mailing a ticket to a customer. Some agents interact directly with customers, but not all. The launch of third-party and others applications will minimize agents' interaction with the global distribution (GDS) travel information database. The system is able to capture 100% of an agent's day in the system.

Mail Agents or BOSA (back office support agents) are users who perform tasks that originate outside of an electronic queuing process (not via phone, or via the GDS). Mail agent skill sets range from novice to expert computer operator with varying degrees of travel knowledge. Mail agents are generally opening and sorting mail, documenting passenger name records (PNR) or the like to initiate workflow in other departments as well as maintaining complete control, movement, storage and destruction of physical accountable documents (airline tickets, travel vouchers, etc) within the system. Whenever possible, BOSA limit movement of physical documents in favor of escalating electronic processing throughout the system infrastructure.

In the system, Supervisors are agents that oversee a group of other agents. Supervisors can work tasks in the same manner as agents and can perform all agent duties as needed. But they also handle escalated issues that an agent is unable to resolve. Additionally, supervisors coach their agents to improve performance and minimize their error rates. In related art system, supervisors do not have all of the information needed to effectively manage and coach their teams. The application allows supervisors to be successful by allowing them to more accurately respond to issues their team members are having and provide their managers with team performance metrics.

Managers oversee the completion of a type of task. They will oversee supervisors. Managers typically do not work on tasks themselves. A manager's primary duty is to ensure that the supervisors maximize the number of tasks that they perform and minimize the number of exceptions created by their teams. In related art systems, managers do not have all of the information that they need to effectively accomplish their primary duty. This system provides them with that information. A manager's definition of success includes upward trends on the amount of tasks completed and downward trends on the amount of exception generated by her teams.

Administrators is defined by the managers to administer the assignment of tasks and certain other features of the system. This user does not exist in related art systems is a new function required by the system. The administrator will require that the system be simple and quickly respond to changes made in the assignment of tasks.

The user environment for all users consists of desktop computers such as those running Microsoft Windows with Internet Explorer. These systems may or may not have the Java Runtime Environment installed. All users will connect through some form of a fully functioning PC using a high speed connection.

Tasks are completed by agents and the agents work on the tasks independently. Tasks require anywhere from less than 1 minute to more than 10 minutes with an average completion time of approximately 2 minutes. Tasks are measured in minutes and seconds. The amount of time to complete a task will vary based on the type of task and complexity of the task in each particular instance.

From the agent's perspective, the system provides three levels of categorization where present systems only have two. The users would prefer a system that allows them to categorize based on type of transaction, followed by two subtypes for fine grained analysis of tasks that are completed by agents.

The system also provides queue management, allowing the agents to intelligently manage and organize their queues. For example, in some circumstances there are 100 queues that various agents are required to manage. The system facilitates that process.

The system also flags invalid items on the queue. In some situations, items are incorrectly placed on particular queues. The agent must remove these items before getting a PNR off of the queue that requires the right kind of work for that queue.

From the supervisor and management perspective, the systems of the related art inadequately capture the amount of tasks that an agent has completed and the amount of time required to complete those tasks. This results in the system being unable to effectively bill its clients. The system of the present invention allows them to effectively manage their teams and bill clients.

By making the system generic, in that it can accommodate different types. of tasks, the infrastructure is in place to use the same basic system in email processing, distribution processing and call processing.

By designing the system to allow for “plug-able” user interfaces the infrastructure is in place to utilize a graphical user interface (GUI) in the future for GDS tasking, a Message Partner replacement interface, and the like. The system is also able to choose an interface presented to the agent based on the type of task that it is delivering to the agent.

All user interfaces run in web browser, as this is the most cost effective way to deliver applications to users.

The system must not create an additional user names and passwords for the agent to remember. This product tightly integrate with the security systems and models used by the system applications.

The system accounts for the client in all of its data tables to facilitate easy reporting and management of the data. The agent is presented with a task and all of the information available to complete that task. The agent may nevertheless have to gather additional information to complete the task; however, the system presents the agent with all of the relevant information that is available at the time the task is delivered to the agent.

The system must capture the amount of time elapsed from the delivery of a task until the agent marks it as complete.

The system must provide a facility for the agent to categorize the task on which they are working. The categorization mechanism must be one that allows for a categorization hierarchy to be created by the system's supervisors or administrators. The hierarchy is an n-level deep tree with parent-child relationships. The system allows multiple root nodes so categories can be grouped at a high level and then drilled into for more specific categories.

The system will only deliver tasks originating from queues to which agents have been assigned by their supervisors.

In the system of the present invention agents have no difficulty switching between tasks for different clients. Some clients have a higher priority than others and agents and thus receive tasks for the highest priority client to which the agent is assigned.

Agents that have permission to work tasks from queues that contain different types of tasks will not receive tasks from different types of queues in one session. This allows the agent to focus on one general type of tasks, rather than switching between disparate types of tasks at random, further improving efficiency.

Escalation procedures are incorporated to allow an agent who is incapable of completing a particular type of task to escalate it to an agent or supervisor who can complete the task.

The escalation procedure is one where the agent assigns the tasks to a group that would be able to accomplish the task. Each group have one queue defined that is to be used for escalations. The agent is able to choose a group based on a plain meaning description of that group.

Some escalation paths require that the Task be placed on a queue in the GDS.

In order to close the system, all time that an agent is logged into the system must be captured. To prevent billing the client for time that an agent is idle or on break that time must be categorized as such.

The Queue Agent has ability to interrupt, or pause, a session. This is based on the fact that Queue Agents receive tasks outside of the system via phone calls or direct tasking from their supervisor. An interrupted task stops the timer and allow the Queue Agent to complete the direct task and then restart the timer when the Queue Agent returns to the application and begins working again.

If a Queue Agent is interrupted, they must be able to log the directed task into the system. This would be the equivalent of an Queue Agent creating a new task, outside of the queuing system. The new task created by the Queue Agent would need to capture the same information as tasks delivered by queue.

When a Queue Agent is unable to receive a task because there are no tasks available the Queue Agent receive a message telling them that there are no tasks available and the system notify their supervisor. The system then send the Queue Agent into an idle time task that categorizes and captures the time that the Queue Agent is idle. The Agent check for new tasks at a frequency defined by their supervisor.

In some instances a task may require the Queue Agent to complete more than one billable transaction. The system allow the Queue Agent to input the number of billable transactions that a task required.

In the event that an agent does not have any tasks on which to work it the system can assign tasks to that agent that are outside of the agents ordinary task set. The agent would receive tasks from a secondary set of queues that the agent will work if the primary set of queues is empty. A mechanism such as this will ensure that agent productivity is maintained even if the agent's primary set of queues is empty and that supervisor intervention is not required to task idle agents.

Mail Agent's job is to convert incoming mail from customers into tasks, therefore, Mail Agent's have the ability to create tasks and place them on queues for Queue Agents to work. Mail Agents will have knowledge of the different queues and types of tasks for Queue Agents.

Mail agent usage times are captured in the same manner as time for Queue Agents. Fore example, the time that it takes a mail agent to process a letter, document a PNR, etc. is captured in the system.

The system in further embodiments has the ability to have reports or presentations that are not defined at the outset to be added to the system with minimal impact to the structure of the system. This accommodates the need for different views of the collected data which are identified once the system is in place.

The system measures agents' productivity based at least on the following: the number of tasks completed per unit of time; the ratio of the amount of time an agent takes to complete tasks to the amount of time set as a threshold for that type of task; the time the agent is spending on their current tasks compared to the threshold time for the same type of task; and the ratio of completed tasks to escalated tasks for the agent.

The number of items on each queue is particularly important for supervisors to effectively direct their teams and assign priorities to queues, and a report or display which shows the queue counts is very helpful in this regard, thus, such a report is provided. Additional reports may be added.

The presentation of managerial data is also important. The system can inform the supervisor of the average time taken to complete a particular type of task, or the breakdown of tasks by category to ensure that their categorization scheme is functioning properly, for example.

Queue prioritization is an essential requirement in that it allows the supervisor to manage the workload by assigning particular queues a priority such that the queue's tasks are completed before another queue's tasks. The priority scheme requested is one that assigns a value between one and ten to the queue. This prioritization is used in the assignment of tasks to the agents. The prioritization scheme only takes into account the assigned priority of the queue. It is implemented in a LIFO manner with the oldest item from the highest priority queue being the next item selected. The depth of a queue is not important in this scheme. For instance if a low priority queue contains 1000 items and a high priority queue contains 2 items, the high priority queue are cleared before assigning any items from the lower priority queue.

This need is based on the fact that the supervisor may need to “move” a task that is on an incorrect queue or a supervisor may need to ensure that a task is completed by assigning it to a queue that more agents have permission to work.

An ‘Actuate Reports’ function is provided that will provide the Managers with the data they need to compile billing reports. At this time there is no related art system in place which could receive automated billing data.

The present invention also include an automated tasking system that assigns tasks to the system's agents. During this process, information regarding the category of task and the time spent on the task is captured by the system. This information can then used by supervisors and managers to bill clients and more effectively manage their teams.

The system of the present invention will not only task the agent, it will facilitate the agent's working of the task. Product Perspective

The system of the present invention may be a self contained application that will work as a supplement to green screen GDS access, or outside application scripts the system of the present invention will run in a web browser and will interact with XFlow. All access is through the users web browser. In a furniture release of the system of the present invention integration with the GDS or features allowing the agent to accomplish GDS tasks through the system of the present invention is included. The system is developed with that perspective in mind. Additionally the system of the present invention is designed in such a manner that disparate types of tasks can be assigned and completed by agents.

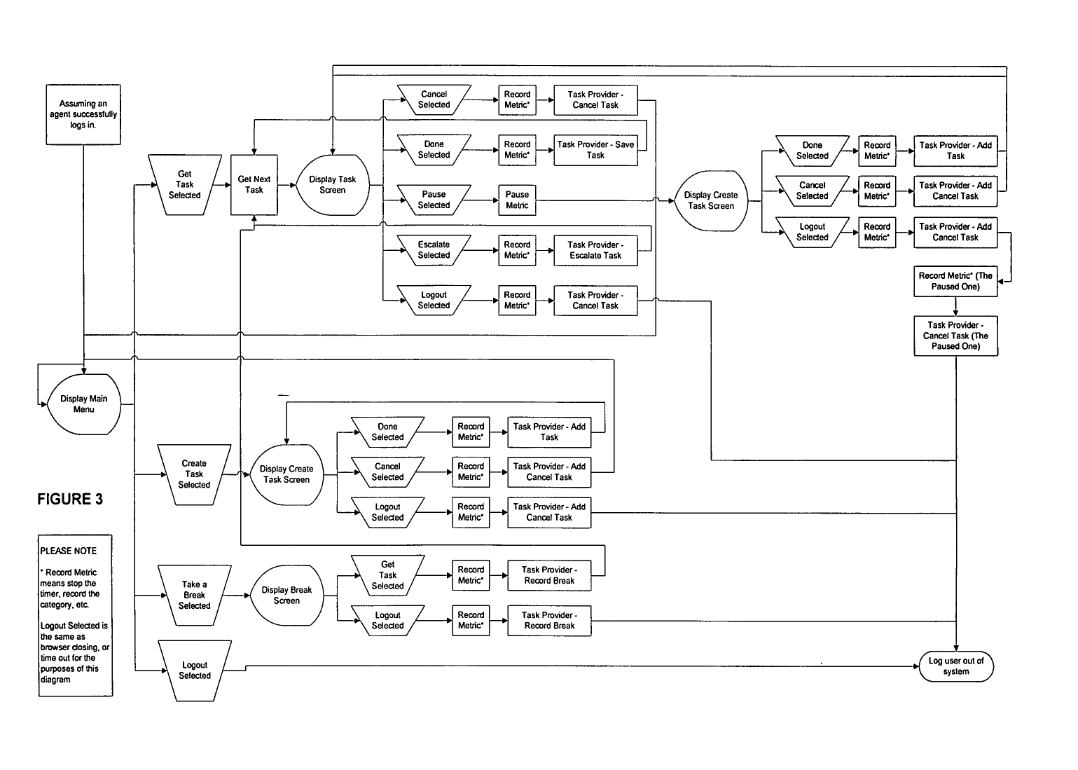

FIG. 2 is a diagram of the system flow according to an embodiment of the present invention. (Items marked one through three would be the order of steps to deliver a task to an agent, the agent complete the task, and the agent logging the results.)

FIG. 3 illustrates the process flow of a software system of the present invention.

As discussed above, the enhanced ability to track agents work time results ins increased revenues. The Agent Tasking System of the present invention can capture this type of information as it assists the agent in completing tasks.

The system also provides for enhanced agent coaching due to availability of performance metrics. In other words, the Supervisor Console will provide this information to the supervisor via a series of reports or a dashboard.

The system further provides for accurate categorization of agents' activity. The Agent Tasking System allows the agents to categorize the work that they are doing as well as allow them to view task completion performance by agent, group or company.

The Queue Manager feature will facilitate working with queues in the system's database. It will control the writing and reading from queues. The features of the Queue Manager is used by other features to either place tasks on queues or remove them from queues.

The Task Manager feature facilitates working with tasks in the system's database. It is used by the front end to receive the next task and is used to time the activity associated with that task and the categorization of that task. It will also provide users with the listing of categories.

The lock manager feature will provide pessimistic locking at the application level to prevent agents from receiving and working the same tasks. The lock manager is generic in that the data that it is locking can come from anywhere in the database.

The queue removal process is specific to the particular GDS and removes PNR's from their respective GDS queue and writes them to the system database.

The Agent Tasking UI is the interface that delivers tasking to the agents.

The Console allows the supervisor to view information regarding the amount of tasks in the system and the activity that agents are performing. This console also allows the supervisor to configure queue priorities and agent responsibilities. The administrative console allows the administrator to configure agents, queues, priorities, and categories.

The task creation UI allows agents, both Queue and Mail, to create new tasks as the need arises. This UI differentiates between agents, such that Queue agents can only create tasks to work themselves or escalate and Mail Agents can create tasks on any Queue to which they are assigned.

FIG. 2 is a block diagram illustrating the process flow of the system according to an exemplary embodiment of the present invention.

Because the system of the present invention is so flexible, its operation is best illustrated through use cases. The tables below describe the operation of the system in a number of exemplary circumstances.

TABLE 1
User Tasking System

| Actor | Queue Agent | |
|---|---|---|
| Brief Description | This system will deliver PNR Locators to the Back | |
| | Office Agents. The PNR Locators will correspond to | |
| | PNR's that need some activity performed on them. The | |
| | agents will get the type of activity that they will need to | |
| | perform from this system and the perform that activity on | |
| | the PNR in the GDS (Green Screen). After completing | |
| | the activity the Back Office Agent will categorize the | |
| | activity performed and save the information to the | |
| | database. The system will write the category, PNR | |
| | Locator and time that it took the agent to complete their | |
| | activity on the PNR. The agent will then request the next PNR | |
| | Locator on which to work. | |
| Basic Flow of Events | 1. | Agent is displayed three options, Get Task, Go On |
| | | Break, and Exit. Get Task is the default selection. |
| | 2. | (Optional) Agent selects Get Task from above. |
| | 3. | Agent clicks the submit button. |
| | 4. | System makes call to Task Manager System to get |
| | | next task. |
| | 5. | Task Manager returns task to system. |
| | 6. | System display task to the agent. (See Use Case - |
| | | Task Screen) |
| | 7. | Agent exits task screen. |
| | 8. | System calls save task method from Task Manager. |
| | 9. | Task Manager writes task to database. |
| | 10. | Agent is returned to step 1. |
| First Alternative Flow | 1. | Same as above. |
| | 2. | Agent selects Go On Break from 1. |
| | 3. | Agent Clicks the submit button. |
| | 4. | Agent is displayed break screen. (See Use Case - |
| | | Break Screen) |
| | 5. | Agent exits break screen. |
| | 6. | System calls save task method from Task Manager |
| | 7. | Task manager writes break task to database. |
| | 8. | Agent is returned to step 1. |
| Second Alternative Flow | 1. | Same as above. |
| | 2. | Agent select exit from 1. |
| | 3. | Agent clicks on the submit button. |
| | 4. | System calls write agents to log out time to |
| | | database. |
| | 5. | Agent is returned to the workflow selector screen. |
| Third Alternative Flow | 1. | Same as above |
| | 2. | Agent clicks cancel button. |
| | 3. | System calls write agents log out time to database. |
| | 4. | Agent is returned to the workflow selector screen. |
| Fourth Alternative Flow | 1. | Same as above. |
| | 2. | Agent closes web browser. |
| | 3. | System calls write agents log out time to database. |

| | |
|---|---|
| Special Requirements | |
| Preconditions | The agent is successfully logged in to the system. |
| Post Conditions | The Agent's log in, log out time is written to the |
| | database. If the agent works a task or goes on break that |
| | task is written to the database. |
| Extension Points | |

TABLE 2
Queue Copy Process

| Actor | XFlow Agent | |
|---|---|---|
| Brief | The Queue Copy Process moves PNR's from | |
| Description | queues in the GDS to queues in the system of the | |
| | present invention's database. | |
| Basic | 1. | Start XFlow Workflow |
| Flow of Events | 2. | Gather Queue Name on which to remove PNR's |
| | | from the Database. |
| | 3. | Connect to GDS. |
| | 4. | Get the next PNR Locator from the queue specified |
| | | in step 2. |
| | 5. | Create a Queue Item object containing the Record |
| | | Locator and the queue name. |
| | 6. | Put the Queue Item in the database. (This could be |
| | | done with JMS). This write must be guaranteed - |
| | | the system of the present invention cannot afford to |
| | | perform the next step if this step fails for any |
| | | reason. |
| | 7. | Proceed to step 2. |
| First | 1. | Steps 1-3 same as Basic Flow of Events. |
| Alternative | 2. | Cannot connect to the GDS. |
| Flow | 3. | Log exception. |
| | 4. | Sleep for a specified amount of time. |
| | 5. | Proceed to Step 2. |
| Second | 1. | Steps 1-3 same as Basic Flow of Events. |
| Alternative | 2. | There are no PNR's on the queue - proceed to |
| Flow | | step 2 and try another queue. |

| | |
|---|---|
| Special | |
| Requirements | |
| Preconditions | XFlow is running. JMS Factory is running. |
| Post Conditions | One or more Record Locators, with Queue Names |
| | have been written to the system of the present invention's |
| | database. Alternatively, an exception has been logged |
| | and the program goes to sleep. |
| Extension | |
| Points | |

TABLE 3
Paid Not Utilized (PNU) Screen

| Actor | Queue Agent, Mail Agent | |
|---|---|---|
| Brief | This screen will allow the agent to “take a break” and not | |
| Description | receive new tasks. This screen allow the agent to | |
| | categorize their type of break and show the agent how | |
| | long they have been on a break. | |
| Basic Flow | 1. | Agent is displayed break screen. |
| of Events | 2. | Screen contains a running timer and a category |
| | | selection box, as well as, a submit and cancel |
| | | button. |
| | 3. | Agent selects a category. |
| | 4. | Agent clicks the submit button. |
| | 5. | A Task Object is created and returned to the User |
| | | Tasking System. |
| | 6. | Screen is closed. |
| First | 1. | Steps 1-2 same as Basic Flow of Events. |
| Alternative | 2. | Agent clicks on submit button. |
| Flow | 3. | Agent is displayed an error message informing the |
| | | agent to select a category. |
| | 4. | Focus returns to the category selection box. |
| | 5. | Repeat Basic Flow of Events. |
| Second | 1. | Steps 1-2 same as Basic Flow of Events. |
| Alternative | 2. | Agent selects a category. |
| Flow | 3. | Agent clicks on the cancel button. |
| | 4. | A Task Object is created and returned to the User |
| | | Tasking System. |
| | 5. | Screen is closed. |
| Third | 1. | Steps 1-2 same as Basic Flow of Events. |
| Alternative | 2. | Agent clicks on the cancel button. |
| Flow | 3. | A Task Object is created with a “generic break” |
| | | category and returned to the User Tasking System. |
| | 4. | Screen is closed. |
| Fourth | 1. | Steps 1-2 same as Basic Flow of Events. |
| Alternative | 2. | Agent Closes browser. |
| Flow | 3. | A Task Object is created and returned to the User |
| | | Tasking System. |
| | 4. | Screen is closed. |

| | |
|---|---|
| Special | |
| Requirements | |
| Preconditions | Agent is logged in and has selected “Break” from the |
| | User Tasking System. |
| Post Conditions | Timing and categorization of the break is returned to the |
| | User Tasking System as a Task Object. |
| Extension | |
| Points | |

TABLE 4
Task Screen

| Actor | Queue Agent | |
|---|---|---|
| Brief Description | The task screen is the main data entry screen for the User | |
| | Tasking System. This screen will present a task to the | |
| | agent and allow them to enter information regarding how | |
| | they processed that task. This screen will also provide | |
| | read only information to the agent pertinent to the task at | |
| | hand, such as the target amount of time to complete an | |
| | average task of the same type as the task presented to the | |
| | agent. | |
| Basic Flow of Events | 1. | Agent is displayed the Task Screen. |
| | 2. | The screen contains the following: |

| | |
|---|---|
| a. | Record Locator of the PNR that the agent is |
| | working |
| b. | The type of action that the agent needs to |
| | perform. |
| c. | A running timer of the amount of time that the |
| | Agent has had the task. |
| d. | An average or expected time to complete the |
| | task. |
| e. | A category selection box. |
| f. | A notes box. |
| g. | A submit and cancel button. |

| | | |
|---|---|---|
| | 3. | The agent visually or using copy enters the PNR |
| | | Locator into their “Green Screen” |
| | 4. | The agent performs the action requested. |
| | 5. | The agent returns to the Task Screen |
| | 6. | The agent selects a category from the category |
| | | selection box. |
| | 7. | The agent enters notes regarding the action |
| | | (optional) |
| | 8. | The agent clicks the submit button. |
| | 9. | A Task Object is returned to the User Tasking |
| | | System containing the category, notes and duration |
| | | of the task. |
| | 10. | The screen closes. |
| First Alternative Flow | 1. | Steps 1-2 same as above. |
| | 2. | The agent is unable to access the “Green Screen” |
| Second Alternative Flow | 1. | Steps 1-5 same as Basic flow Events. |
| | 2. | The agent clicks the Submit button. |
| | 6. | Agent is displayed an error message informing the |
| | | agent to select a category. |
| | 7. | Focus returns to the category selection box. |
| | 3. | Repeat Basic Flow of Events. |
| Third Alternative Flow | 1. | Steps 1-3 same as Basic Flow of Events. |
| | 2. | The agent determines that the action required is |
| | | beyond his or her skill set. |
| | 3. | The agent returns to the Task Screen. |
| | 4. | The agent chooses to escalate the item. (There is a |
| | | mechanism to provide this functionality) |
| | 5. | The Task Object is returned to the User Tasking |
| | | System with the “ESCALATED” category and the |
| | | time that it took the agent to make this |
| | | determination. |
| | 6. | The Task Object is placed on the escalation queue |
| | | that is defined for the agent or queue. |
| | 7. | The screen closes. |
| Fourth Alternative Flow | 1. | Steps 1-2 same as Basic Flow of Events. |
| | 2. | The agent clicks on the Cancel button. |
| | 3. | The Task Object is returned to the User Tasking |
| | | System with “CANCELLED ACTION” category |
| | | and the duration of time that it took the user to |
| | | cancel. |
| | 4. | The task is returned to the original queue. |
| | 5. | The screen closes. |
| Fifth Alternative Flow | 1. | Steps 1-2 same as Basic Flow of Events. |
| | 2. | The agent closes the browser. |
| | 3. | The Task Object is returned to the User Tasking |
| | | System with “CANCELLED ACTION” category |
| | | and the duration of time that it took the user to close |
| | | the window. |
| | 4. | The task is returned to its original queue. |

| | |
|---|---|
| Special Requirements | |
| Preconditions | Agent is logged into the system and has select “Get |
| | Task” from the User Tasking System. |
| Post Conditions | A Task Object is returned to the User Tasking System |
| | that contains information regarding the Agents activity |
| | with that task. |
| Extension Points | |

TABLE 5
Task Manager - Get Task

| Actor | XFlow UI Agent | |
|---|---|---|
| Brief | The Task Manager is the primary interface for the User | |
| Description | Tasking System to interact with Tasks. The Task | |
| | Manager is a service that coordinates between other | |
| | services to provide the facilities to retrieve and save | |
| | tasks. This use case concerns the Get Task method of the | |
| | Task Manager | |
| Basic | 1. | User Tasking System makes call to the getTask |
| Flow of Events | | method. (Parameters: Agent ID, Client, Task |
| | | Type, etc.) |
| | 2. | Task Manager will then call the Queue Manager |
| | | service's (Use Case - Queue Manager) getNext |
| | | method. (Parameters: Agent ID, Client, Task |
| | | Type) |
| | 3. | The Queue Manager service will return a Queue |
| | | Item object to the Task Manager. |
| | 4. | The Task Manager examines the Queue Item and |
| | | calls the Lock Manager to lock the row in the |
| | | database. (See Use Case - Lock Manager —Lock) |
| | 5. | The Task Manager will convert the Queue Item |
| | | object to a Task Object and return it to the User |
| | | Tasking System. |
| First | 1. | Steps 1-2 same as above. |
| Alternative | 2. | The Queue Manager service returns a “no items on |
| Flow | | queue” exception. |
| | 3. | The Task Manager catches the exception. |
| | 4. | The Task Manager throws a “no tasks available” |
| | | exception. |
| | 5. | The User Tasking System catches the exception. |
| | 6. | The system notifies the user that there are not tasks |
| | | available and that their supervisor will instruct them |
| | | on what actions to take. |
| | 7. | The system will notify the supervisor that the agent |
| | | has no tasks on queue and is idle. |
| | 8. | The system will create an idle task and time and |
| | | categorize the agents time as idle. |
| Second | 1. | Steps 1-2 same as Basic Flow of Events. |
| Alternative | 2. | The Queue Manager service returns a database |
| Flow | | exception or an unexpected exception. |
| | 3. | The Task Manager catches the exception. |
| | 4. | The Task Manager writes to the system log. |
| | 5. | The Task Manager throws a “no tasks available” |
| | | exception. |
| | 6. | The User Tasking System catches the exception. |
| Third | 1. | Steps 1-4 same as Basic Flow of Events. |
| Alternate Flow | 2. | The Lock Manager returns an exception. |
| | 3. | The Task Manager catches the exception. |
| | 4. | The Task Manager logs the exception to the system |
| | | log. |
| | 5. | The Task Manager throws a “no tasks available” |
| | | exception. |
| | 6. | the User Tasking System catches the exception. |

| | |
|---|---|
| Special | |
| Requirements | |
| Preconditions | XFlow and the database are available. |
| Post Conditions | An initialized Task object is returned to the caller or an |
| | exception is thrown. |
| Extension | |
| Points | |

TABLE 6
Task Manager - Save Task

| Name | Task Manager - Save Task | |
|---|---|---|
| Actor | XFlow Agent | |
| Brief | The Task Manager is the primary interface for the User | |
| Description | Tasking System to interact with Tasks. The Task | |
| | Manager is a service that coordinates between other | |
| | services to provide the facilities to retrieve and save | |
| | tasks. This use case concerns the Save Task method of | |
| | the Task Manager | |
| Basic | 1. | The User Tasking System calls the Save Task |
| Flow of Events | | method of the Task Manager service. (Parameters: |
| | | AgentID, Client, TaskType, Task). |
| | 2. | The Task Manager writes the Task to the database. |
| | | (via JMS or straight JDBC) |
| | 3. | The Task Manager calls the Lock Manager to |
| | | unlock the row in database (See Use Case - Lock |
| | | Manager - Unlock) |
| | 4. | The Task Manager calls the Queue Manager's |
| | | Queue Remove method (See Use Case - Queue |
| | | Manager - Remove) to remove the Task from the |
| | | queue. |
| | 5. | The Task Manager returns a confirmation to the |
| | | User Tasking System that the Task was successfully |
| | | written to the database. |
| First | 1. | Steps 1-2 same as above. |
| Alternative | 2. | The database write throws an exception. |
| Flow | 3. | The Task Manager catches the exception. |
| | 4. | The Task Manager or its surrogates attempts to |
| | | write again, or stores the data so that it can be |
| | | written at a point when the database is available. |

| | |
|---|---|
| Second | |
| Alternative | |
| Flow | |
| Special | |
| Requirements | |
| Preconditions | Caller has an initialized, fully populated Task. |
| Post Conditions | The Task is written to the database or an exception is |
| | thrown. |
| Extension | |
| Points | |

TABLE 7
Lock Manager - Lock

| Name | Lock Manager - Lock | |
|---|---|---|
| Actor | XFlow Agent | |
| Brief | Lock Manager is the service that facilitates locking and | |
| Description | unlocking rows in the database. This service is of a | |
| | generic nature such that any application can use it. This | |
| | use case explores the Lock method of the Lock Manager | |
| | which will “lock” a row in the database. | |
| Basic | 1. | Call is made to the Lock method of the Lock |
| Flow of Events | | Manager. (Parameters: Key, Table, User ID, |
| | | Application) |
| | 2. | Lock Manager attempts to insert a row into the |
| | | Lock Table. (This must be a direct write to the DB - |
| | | JDBC). |
| | 3. | Lock Manager successfully inserts the row. |
| | 4. | Lock Manager returns “successful lock” to the |
| | | caller. (Actual return value is left to the |
| | | implementor) |
| First | 1. | Steps 1-2 same as above. |
| Alternative | 2. | An exception is thrown and the insert to the |
| Flow | | database fails. |
| | 3. | Lock Manager catches the exception. |
| | 4. | Lock Manager returns “unable to lock” to the caller. |

| | |
|---|---|
| Second | |
| Alternative | |
| Flow | |
| Special | |
| Requirements | |
| Preconditions | Parameters are valid. XFlow is available. |
| Post Conditions | A row is written to the lock table in the database |
| | containing the parameters passed in to the method and a |
| | positive response is returned to the caller if the lock is |
| | obtained. Alternatively, no row is written to the database |
| | and a negative response is returned to the caller if the |
| | lock cannot be obtained. |
| Extension | |
| Points | |

TABLE 8
Lock Manager - Unlock

| Actor | XFlow Agent | |
|---|---|---|
| Brief | Lock Manager is the service that facilitates locking and | |
| Description | unlocking rows in the database. This service is of a | |
| | generic nature such that any application can use it. This | |
| | use case explores the Unlock method of the Lock | |
| | Manager which will “unlock” a row in the database. | |
| Basic | 1. | Call is made to the Unlock method of the Lock |
| Flow of Events | | Manager. (Parameters: Key, Table, User ID, |
| | | Application). |
| | 2. | Lock Manager attempts to delete the row from the |
| | | database. |
| | 3. | Lock Manager successfully deletes the row or the |
| | | row does not exist and as such the delete succeeds, |
| | | but no rows are affected. |
| | 4. | A positive response is returned to the caller. |
| First | 1. | Steps 1-2 same as above. |
| Alternative | 2. | The delete operation fails. (An exception may be |
| Flow | | thrown). |
| | 3. | Lock Manager catches the exception (if one exists). |
| | 4. | A negative response is returned to the caller. |

| | |
|---|---|
| Second | |
| Alternative | |
| Flow | |
| Special | |
| Requirements | |
| Preconditions | Parameters are valid. |
| Post Conditions | The lock in the database is removed from the Lock table |
| | and a positive response is returned. Alternately, the lock |
| | is not removed from the database and a negative response |
| | is returned. |
| Extension | |
| Points | |

TABLE 9
Queue Manager - Put

| Actor | Agent | |
|---|---|---|
| Brief | The Queue Manager facility is a service that assists in | |
| Description | working with Queues. This use case explores the Put | |
| | method which will place an item on a Queue in the | |
| | database. | |
| Basic | 1. | Caller calls Put method of Queue Manager. |
| Flow of Events | | (Parameters: Queue, Key, Object to be placed on |
| | | Queue). |
| | 2. | Put method inserts the row into the database. |
| | 3. | Nothing is returned to the caller. |
| First | 1. | Steps 1-2 same as above. |
| Alternative | 2. | The insertion causes and exception. |
| Flow | 3. | Queue Manager logs the exception in the System |
| | | Log. |
| | 4. | Queue Manager throws an “unable to put item on |
| | | queue” exception to the caller. |

| | |
|---|---|
| Second | |
| Alternative | |
| Flow | |
| Special | |
| Requirements | |
| Preconditions | Parameters are properly formatted and valid. |
| Post Conditions | Key and Object are placed on the Queue specified in the |
| | call. Alternatively, an exception is thrown in the event of |
| | an error. |
| Extension | |
| Points | |

TABLE 10
Queue Manager - Get

| Actor | Agent | |
|---|---|---|
| Brief | The Queue Manager facility is a service that assists in | |
| Description | working with Queues. This use case explores the Get | |
| | method which will get an item on a specific Queue from | |
| | the Database. | |
| Basic | 1. | Automation Agent calls the Get method of the |
| Flow of Events | | Queue manager. (Parameters: Queue, Agent ID, |
| | | Object Type). |
| | 2. | Queue Manager issues a select statement against the |
| | | database to get the oldest item from the highest |
| | | priority queue to which the Agent (Agent ID) is |
| | | permitted to work. |
| | 3. | The object retrieved from the queue is returned to |
| | | the Agent. |
| First | 1. | Steps 1-2 same as above. |
| Alternative | 2. | There are no items on the queue. |
| Flow | 3. | Queue Manager throws an “no items on queue” |
| | | exception. |
| Second | 1. | Steps 1-2 same as above. |
| Alternative | 2. | A database exception occurs. |
| Flow | 3. | Queue Manager throws an “database connectivity” |
| | | exception. |

| | |
|---|---|
| Special | |
| Requirements | |
| Preconditions | Parameters are valid. |
| Post Conditions | A Queue Item is returned to the caller corresponding to |
| | the oldest item on the highest priority queue for the agent |
| | in question. Alternatively, an exception is thrown in the |
| | event that there are no items on the queue or a database |
| | exception occurs. |
| Extension | |
| Points | |

TABLE 11
Queue Manager - Remove

| Actor | Agent |
|---|---|
| Brief Description | The Queue Manager facility is a service that assists in |
| | working with Queues. This use case explores the |
| | Remove method of the Queue manager. The Remove |
| | method will remove an item from a queue in the |
| | database. |
| Basic Flow | 1. Caller calls the Remove method. (Parameters: |
| of Events | Queue Item, Key) |
| | 2. Queue Manager deletes the item from the database |
| | queue. (This could be marking it as deleted or |
| | moving it to a worked queue.) |
| | 3. Queue Manager removes the item from the Queue |
| | in the GDS. |
| | 4. Queue Manager does not return anything to the |
| | caller. |
| First Alternative | 1. Steps 1-2 same as above. |
| Flow | 2. An exception occurs and Queue Manager cannot |
| | remove the item from the database. |
| | 3. Queue Manager catches the exception. |
| | 4. Queue Manager throws an “unable to remove item” |
| | exception to the caller. |
| Second | 1. Steps 1-3 same as above. |
| Alternative Flow | 2. An exception occurs and the Queue manager cannot |
| | remove the item from the GDS queue. |
| | 3. The queue manager throws an “unable to remove |
| | item” exception to the caller. |
| Special | This process needs more research. |
| Requirements | |
| Preconditions | Parameters are valid. |
| Post Conditions | Queue Item is removed from the queue. Alternatively, |
| | an exception is thrown in the event that Queue |
| | Manager is unable to remove the item from the queue. |
| Extension Points | |

TABLE 12
Supervisor Console - Main

| | |
|---|---|
| Actor | Supervisor/Manager |

| Brief | The Supervisor Console will provide a set of tools for the | |
|---|---|---|
| Description | supervisor to facilitate managing their teams and their | |
| | tasks. The console will allow the supervisor to prioritize | |
| | queues, assign agents to queues, create categories and | |
| | view task traffic throughout the system, specifically | |
| | regarding their team. | |
| Basic Flow | 1. | Supervisor is displayed the main screen. This |
| of Events | | screen provides access methods to the following |
| | | features. |
| | | a. Queue Management. |
| | | b. Category Management. |
| | | c. Agent Management |
| | | d. Dashboard. |
| | | e. Reports. |
| | 2. | The supervisor chooses one of the access methods |
| | | above and is taken to a screen corresponding to that |
| | | access point. All of the access points above are |
| | | detailed in use cases below. |
| First | | |
| Alternative | | |
| Flow | | |
| Second | | |
| Alternative | | |
| Flow | | |
| Special | | |
| Requirements | | |

| | |
|---|---|
| Preconditions | Supervisor is logged into the system. |
| Post Conditions | Main Supervisor Console screen is displayed. |
| Extension | |
| Points | |

TABLE 13
Supervisor Console - Queue Prioritization

| Actor | Supervisor/Administrator |
|---|---|
| Brief Description | The Queue Prioritization Screen will allow the |
| | supervisor to assign priorities to queues. The |
| | Supervisor will not be permitted to add or |
| | remove queues, only assign priority. The priorities |
| | is on a 1-10 scale. |
| Basic Flow | 1. The supervisor is displayed the Queue Prioritization |
| of Events | Screen. |
| | 2. The screen contains a mechanism for selecting a |
| | queue to prioritize. |
| | 3. The Supervisor selects a Queue. |
| | 4. The information regarding the queue is displayed. |
| | 5. The supervisor then changes the priority of the |
| | queue. |
| | 6. The supervisor chooses to save her changes. |
| | 7. The Queue Prioritization screen saves the priority to |
| | the database. |
| | 8. The focus returns to the queue select mechanism. |
| | 9. The supervisor exits the screen or returns to step 3. |
| First Alternative | 1. Steps 1-5 the same as the basic flow of events. |
| Flow | 2. The supervisor chooses to cancel her changes. |
| | 3. The changes are discarded. |
| | 4. The queue is no longer selected. |
| | 5. The queue selection mechanism has the focus. |
| | 6. The supervisor exits the screen or returns to step 3. |
| Second | 1. Steps 1-7 same as Basic Flow of Events. |
| Alternative Flow | 2. The database save fails and throws an exception. |
| | 3. The Queue Prioritization Screen catches the |
| | exception. |
| | 4. The Queue Prioritization Screen writes the |
| | exception to the System log. |
| | 5. The Queue Prioritization Screen displays a message |
| | to the user stating that it is unable to save changes |
| | at this time. |
| Special | |
| Requirements | |
| Preconditions | The user is logged into the system and has chosen to |
| | display the queue prioritization screen. |
| Post Conditions | The priority of 1 or more queues is changed in the |
| | database depending on the actions of the user. There |
| | could be no changes to any queue priorities from this |
| | screen depending on user action. The user is returned |
| | to the Supervisor Console Main screen. |
| Extension Points | |

TABLE 14
Supervisor Console - Category Management

| Actor | Supervisor/Administrator |
|---|---|
| Brief | The Category Management screens will allow the |
| Description | Supervisor to add, modify or remove categories from the |
| | application. |
| Basic Flow | This screen is a typical data entry screen. The user is |
| of Events | presented a method to select an existing category for |
| | update or removal, add an additional category or exit the |
| | screen. The UI for adding/modifying data will present |
| | the category name, category description and a |
| | mechanism for selecting the categories parent. All |
| | categories will have a parent, even if that parent is the |
| | root category, which is defined by the system. |
| First | |
| Alternative | |
| Flow | |
| Second | Alternative |
| Flow | |
| Special | |
| Requirements | |
| Preconditions | The user is logged in and has selected the Category |
| | Management Screen. |
| Post Conditions | Any changes made by the user are persisted to the |
| | database and the user is returned to the main supervisor |
| | screen. |
| Extension | |
| Points | |

TABLE 15
Supervisor Console - Agent Management

| Actor | Supervisor |
|---|---|
| Brief | The Agent Management screens will allow the user to |
| Description | create or remove connections between agents and |
| | queues. |
| Basic Flow | The user is presented a screen that contains a list of |
| of Events | agents and a list of queues. The user will select an agent |
| | or a queue on which to configure the connections. If the |
| | user selects an agent then the queues and queue |
| | description on which that agent is assigned is displayed. |
| | The user then have the opportunity to |
| | 1. Remove a queue from the agent's list of queues. |
| | 2. Add a queue to the agent's list of queues. |
| | 3. Cancel. |
| | All changes that the user makes is persisted to the |
| | database upon the user choosing “save changes” or some |
| | similar functionality. |
| First | If the user selects a queue on which to view the |
| Alternative | connections, then the user is displayed a list of agents |
| Flow | that are assigned to that queue. The user then has the |
| | opportunity to: |
| | 1. Remove an agent from the queue's list of agents. |
| | 2. Add an agent to the queue's list of agents. |
| | 3. Cancel. |
| | All changes that the user makes are persisted to the |
| | database upon the user choosing “save changes” or some |
| | similar functionality. |
| Second | |
| Alternative | |
| Flow | |
| Special | If the user has made changes and has not committed |
| Requirements | those changes then the user is warned that changes made |
| | is lost if the user does not choose to save the changes. |
| Preconditions | The user is logged in to the system and has chosen to |
| | view the Agent Management Screen. |
| Post Conditions | Any changes made by the user are persisted to the |
| | database and the user is returned to the main supervisor |
| | screen. |
| Extension | |
| Points | |

TABLE 16
Supervisor Console - Dashboard

| Actor | Supervisor |
|---|---|
| Brief Description | The dashboard will display the supervisor information |
| | regarding the flow of tasks through their collection of |
| | agents and queues. The dashboard display warnings |
| | when data thresholds are crossed. The dashboard |
| | allows the user to drill down into a more detailed view |
| | of the data that the user has selected. |
| Basic Flow | The basic flow of events for the dashboard is that the |
| of Events | dashboard is displayed and the user observes and exits |
| | the dashboard. |
| First | The user clicks on a “hotspot” on the dashboard and is |
| Alternative Flow | taken to a corresponding report or view that allows |
| | them to see detail regarding the particular hotspot |
| | that they have chosen. |
| Second | |
| Alternative Flow | |
| Special | |
| Requirements | |
| Preconditions | The user is logged in and has chosen to view the |
| | dashboard. |
| Post Conditions | The user is displayed the dashboard. |
| Extension Points | |

TABLE 17
Supervisor Console - Reports

| Actor | Supervisor/Manager |
|---|---|
| Brief Description | The Reports screen is an interface to reports regarding |
| | agent performance. This screen can be a link directly |
| | to the system of the present invention's |
| | Actuate reports. |
| Basic Flow | The user is displayed the reports screen. This screen |
| of Events | contains links to Actuate reports that correspond to this |
| | system. |
| First | |
| Alternative Flow | |
| Second | |
| Alternative Flow | |
| Special | |
| Requirements | |
| Preconditions | The user is logged in and has chosen to view reports. |
| Post Conditions | The user is displayed the reports screen. |
| Extension Points | |

TABLE 18
Administrative Console - User Administration

| Actor | Administrator |
|---|---|
| Brief | The User Administration Screens allow the administrator |
| Description | to add new users to the system, modify attributes of |
| | existing users and remove users from the system. This |
| | system is tightly coupled with the system of the present |
| | invention security model and its interfaces for user |
| | management. |
| Basic Flow | The User Administration Screen allows the administrator |
| of Events | to select a user and view and modify their attributes. The |
| | modifications are written to the database. |
| First | The user can select a mechanism to add a user to the |
| Alternative | system. The system would allow the administrator to |
| Flow | enter all of the appropriate data required to add user and |
| | then allow the administrator to save or commit their |
| | changes. |
| Second | |
| Alternative | |
| Flow | |
| Special | |
| Requirements | |
| Preconditions | The administrator is logged in and has selected to view |
| | the User Administration screen. |
| Post Conditions | A user's profile has been modified, a user has been added |
| | or no changes have occurred. Any changes are written to |
| | the database. |
| Extension | |
| Points | |

TABLE 19
Administrative Console - Category Administration

| Actor | Administrator |
|---|---|
| Brief Description | The Category Administration screens are a |
| | duplicate of use case - Supervisor Console - |
| | Category Management. The administrator |
| | is allowed to create new root categories. |
| Basic Flow of Events | |
| First Alternative Flow | |
| Second Alternative Flow | |
| Special Requirements | |
| Preconditions | |
| Post Conditions | |
| Extension Points | |

TABLE 20
Administrative Console - Queue Administration

| Actor | Administrator |
|---|---|
| Brief | The Queue Administration screen will allow the |
| Description | administrator to add new queues to the system, remove |
| | queues from the system, change the priority of queues |
| | and change attributes regarding existing queues. |
| Basic Flow | This is a typical data entry system with a selection |
| of Events | mechanism as the first step, either existing or new. The |
| | operations are not be committed to the database until the |
| | user chooses to do so. The user is allowed to cancel any |
| | operation prior to choosing to save their actions. |
| First | |
| Alternative | |
| Flow | |
| Second | |
| Alternative | |
| Flow | |
| Special | |
| Requirements | |
| Preconditions | The user is logged in and has chosen to go to the queue |
| | management screen. |
| Post Conditions | Queues are modified, added or removed in the database |
| | based on the actions of the users. |
| Extension | |
| Points | |

TABLE 21
Task Creation Screen - Mail Agent

| Actor | Mail Agent | |
|---|---|---|
| Brief Description | The Task Creation Screen - Mail Agent is a screen to | |
| | allow Mail Agents to create tasks and assign them to | |
| | queues. | |
| Basic | 1. | The Agent is displayed a form that contains the |
| Flow of Events | | following data entry items: |

| | |
|---|---|
| a. | Queue |
| b. | Task ID |
| c. | Notes |
| d. | Timing (Read only - this is to capture the |
| | timing of the agent) |

| | 2. | The agent selects a queue, enters a Task ID or |
|---|---|---|
| | | key, enters notes that may be pertinent to the |
| | | task. |
| | 3. | The agent chooses to “save” the task. |
| | 4. | The task is written to the database. |
| | 5. | The agent is returned to the Main agent screen. |
| First | 1. | Same as above. |
| Alternative Flow | 2. | The agent does not enter a queue. |
| | 3. | The agent chooses to “save” the task. |
| | 4. | An error is returned to the agent informing |
| | | them that queue is required. |
| Second | Repeat First alternate flow for Task ID. | |
| Alternative Flow | | |
| Third | 1-3 | Same as Basic Flow of Events |
| Alternative Flow | 3. | The database is unable to save the task, an |
| | | exception is thrown. |
| | 4. | Inform the user that the task was not written to |
| | | the database. |
| | 5. | Ask the user to try again. |

| | |
|---|---|
| Special | |
| Requirements | |
| Preconditions | The agent has chosen to add a task. |
| Post Conditions | The task is added or a database exception is returned. |
| Extension Points | |

TABLE 22
Task Creation Screen - Queue Agent

| Actor | Queue Agent | |
|---|---|---|
| Brief | This screen will allow the queue agent to create a new | |
| Description | task. This mode of work is the exception rather than the | |
| | rule and allow the agent to enter information just as a | |
| | regular task. This screen is different the Task Creation | |
| | Screen - Mail Agent in that the agent will not be | |
| | allowed to assign the task to a queue, it must be | |
| | completed or escalated at the time of creation. | |
| Basic Flow | 1. | The agent is displayed the task screen in an “add” |
| of Events | | mode. It displays entry boxes for Task Key (PNR |
| | | Locator), Category and Notes. The queue is |
| | | marked as “Direct Task” and the agent can escalate, |
| | | save or cancel the task. |
| | 2. | The agent enters in the task key, the category and |
| | | optionally notes. |
| | 3. | The agent chooses to save the task. |
| | 4. | The task is written to the database. |
| | 5. | The agent is returned to the previous screen. (This |
| | | could be the main menu or a queue task that was |
| | | interrupted.) |
| First | 1. | Same as Basic Flow of Events. |
| Alternative | 2. | The agent chooses to cancel the task. |
| Flow | 3. | A “Cancel” task is created. |
| | 4. | The “Cancel” task is written to the database. |
| | 5. | The agent is returned to the previous screen. |
| Second | 1. | Same as Basic Flow of Events. |
| Alternative | 2. | The agent may or may not enter any data in Task |
| Flow | | Key, Category and Notes. |
| | 3. | The agent chooses to escalate the task. |
| | 4. | The task is written to the database as an escalated |
| | | task. |
| | 5. | The task is placed on the escalation queue. |
| | 6. | The agent is returned to the previous screen. |

| | |
|---|---|
| Special | |
| Requirements | |
| Preconditions | The agent has chosen to add a task. |
| Post Conditions | The task is added to the database or a database exception |
| | is returned. |
| Extension | |
| Points | |

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for automating workflow associated with travel agents, comprising:
a plurality of first agents;
at least one of a second agent;
at least one unit of incoming work, said second agent examining said unit of incoming work and creating a new task associated with said unit of work, said task defined at least in part by a skill identifier associated with the agent skill required to complete said task;
a list of skill identifiers associated with each of said first agents corresponding to the skills possessed by said agent;
at least one task queue corresponding to each of said first agents;
assigning said new task to one of said first agents, said one of said first agents having a skill identifier in its list corresponding to the skill identifier of the task;
a completion time for said new task determined by subtracting the time the task was assigned to the first agent from the time the task was completed by said first agent.
